(19) United States
(12) Patent Application Publication
(10) Pub. No.: US 2009/0156772 A1
(43) Pub. Date: Jun. 18, 2009

(54) Melt processed materials for medical articles

(75) Inventors: Frederick H. Strickler, Natick, MA (US); Barron Tenney, Haverhill, MA (US); Mark Boden, Harrisville, RI (US)

Correspondence Address: MAYER & WILLIAMS PC, 251 NORTH AVENUE WEST, 2ND FLOOR, WESTFIELD, NJ, 07090, US

(73) Assignee: Boston Scientific Scimed, Inc., Maple Grove, MN (US)

(21) Appl. No.: 12/001,656

(22) Filed: Dec. 12, 2007

(51) Int. Cl. B28B 1/14; C08F 6/00; C08F 20/10; C08F 236/06; C08F 10/02; C08F 12/08

(52) U.S. Cl. 526/328; 528/502 R; 526/340; 526/348.2; 264/299

(57) ABSTRACT

In accordance with an aspect of the invention, methods of forming medical articles are provided, which comprise (a) preparing a melt phase that comprises a molten polymer and a supercritical fluid, (b) forming a polymeric region from the melt phase, and (c) cooling the polymeric region. In certain embodiments, the supercritical fluid is formed from chemical species (e.g., CO₂, propane, etc.) that are gases at room temperature (25° C.) and atmospheric pressure (1 atm). According to another aspect of the present invention, medical articles are provided which comprise melt-processed polymeric materials. The polymeric materials have a composition that cannot be melt processed without the use of melt-viscosity reducing additives due to thermal degradation, and yet the polymeric material does not contain such additives.

### FIELD OF THE INVENTION

The present invention relates generally to polymeric medical articles, including implantable or insertable polymeric medical devices, and to methods of making the same.

### BACKGROUND OF THE INVENTION

A supercritical fluid is a substance that has been subjected to conditions that are above the critical temperature and critical pressure of that substance. This range of conditions is illustrated in the generalized schematic phase diagram of FIG. 1. The supercritical region is the range of conditions that are found in the upper right-hand portion of FIG. 1, where the temperature is above the critical temperature (T_{c}) and the pressure is above the critical pressure (P_{c}). This combination of critical temperature and pressure is known as the critical point. Stated another way, a substance becomes a supercritical where its temperature and pressure are above its critical point (i.e., T>T_{c} and P>P_{c}). At a temperature below T_{c} or pressure below P_{c} the substance is a non-supercritical solid, liquid or gas. Various non-supercritical phase transitions between solid and liquid (melting), between liquid and gas (boiling), and between solid and gas (sublimation) are also illustrated in FIG. 1.

A supercritical fluid exhibits both gas-like and liquid-like properties. The density of the supercritical fluid may be similar to that of a very dense gas and its diffusivity may be similar to diffusivities normally associated with gases, while its solubility properties may be similar to that of a liquid. Hence, a fluid in the supercritical state is sometimes described as having the behavior of a very mobile liquid, in which the solubility behavior approaches that of the liquid phase while penetration into a solid matrix is facilitated by the gas-like transport properties. Supercritical fluids will exhibit these properties as long as they are maintained in their supercritical range. However, when either the temperature or the pressure of a supercritical fluid drops below its associated critical point, the fluid is no longer classified as a supercritical fluid, because it no longer posses some or all of the mixed property characteristics associated with a substance in this range.

Supercritical fluids have been used in imbibing medical devices with therapeutic agents. See, e.g., U.S. Patent Application No. 20030044514 to Richard and 2006/0127442 to Helmus.

Polymers are widely used for the preparation of devices for medical applications. Many medical devices are used for long term implantation in the human body. Typical requirements for the selection of a polymeric material for an implantable medical device are that the material, once fabricated and sterilized, have good biocompatibility, low cytotoxicity and low carcinogenicity, among other characteristics.

Many polymeric materials are able to meet the above requirements as pre-processed materials, but fail to do so subsequent to melt processing. Polymeric materials are converted into a melt phase during melt processing. For a given melt processing technique, there is an acceptable melt viscosity range which is typically required. Melt viscosity may be adjusted, for example, by varying the temperature of the melt. Unfortunately, for some materials, one arrives at the decomposition temperature of the polymer prior to achieving an acceptably low melt viscosity. High melt viscosity is a particularly acute problem in processing high molecular weight polymers. See, e.g., S. P. Nalawade et al., Prog. Polymer Sci., 2006, 31, 19-41.

This problem is commonly addressed through the use of processing additives, such as resins, plasticizers, waxes and/or anti-oxidants. Resins, plasticizers and waxes are added to lower the temperature that is required to facilitate sufficient polymer flow during processing (i.e., to lower the melt viscosity), whereas antioxidants are added to protect the polymer where high temperatures are employed. Typical resin and plasticizer additives are polypropylene and di-octyl phthalate respectively. A typical wax is paraffin wax. A typical anti-oxidant is phosphate blended with a phenolic stabilizer. Additive-based techniques are common for polymeric materials that will not be exposed to the human environment. However, the additives may create problems when implanted or inserted into a subject, particularly when used in devices that are engineered for long term implantation (i.e., greater than or equal to 1 month), whereby the additives have the opportunity to leach into the surrounding tissue.

Another method which has been described to address the issue of polymer degradation is to exclude oxygen while processing at temperature. This method helps in the case of some polymers, but does not completely solve the problem of degradation for others.

### SUMMARY OF THE INVENTION

In accordance with an aspect of the invention, methods of forming medical articles are provided, which comprise (a) preparing a melt phase that comprises a molten polymer and a supercritical fluid, (b) forming a polymeric region from the melt phase, and (c) cooling the polymeric region. In certain embodiments, the supercritical fluid is formed from chemical species that are gases at room temperature (25° C.) and atmospheric pressure (1 atm).

According to another aspect of the present invention, medical articles are provided which comprise melt-processed polymeric materials. The polymeric materials have a composition that cannot be melt processed without the use of melt-viscosity-reducing additives due to thermal degradation, and yet the polymeric material does not contain such additives.

An advantage of the invention is that the melt viscosity of a given polymeric material can be reduced during melt processing, without resorting to chemical additives that remain in the polymeric material subsequent to processing.

Another advantage is that post-processing steps (e.g., steps in which additives such as plasticizers are leached from the polymeric material, etc.) may be avoided.

Another advantage of the invention is that polymers that cannot ordinarily be melt processed without resorting to melt-viscosity-reducing additives, due to high-temperature degradation, can be both melt processed and free of residual additives.

These and other aspects, embodiments and advantages of the present invention will become immediately apparent to those of ordinary skill in the art upon review of the Detailed Description and Claims to follow.

### BRIEF DESCRIPTION OF THE DRAWING

FIG. 1 is a generalized schematic phase diagram of a hypothetical substance, illustrating the supercritical range of conditions for the substance.

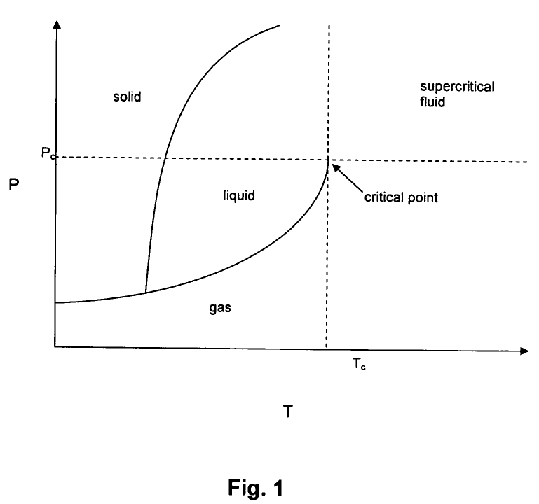

### DETAILED DESCRIPTION OF THE INVENTION

A more complete understanding of the present invention is available by reference to the following detailed description of numerous aspects and embodiments of the invention. The detailed description of the invention that follows is intended to illustrate but not limit the invention.

According to an aspect of the present invention, medical articles are provided which comprise melt-processed polymeric materials. The polymeric materials have a composition that cannot be melt processed without the use of melt-viscosity reducing additives due to thermal degradation, and yet the polymeric material does not contain such additives.

Medical articles in accordance with the present invention may be prepared, for example, using supercritical fluids as melt-viscosity reducing additives. In certain embodiments, the supercritical fluids are formed from chemical species (e.g., CO₂, propane, etc.) that are gases at room temperature (25° C.) and atmospheric pressure (1 atm).

In accordance with a further aspect of the invention, methods of forming medical articles are provided, which comprise (a) preparing a melt phase that comprises a molten polymer and a supercritical fluid, (b) forming a polymeric region from the melt phase and (c) cooling the polymeric region.

For example, a melt phase that comprises a molten polymer and a supercritical fluid can be prepared by combining a polymeric material and a supercritical fluid in a suitable mixing device, for example, an extruder (e.g., a single screw extruder, twin screw extruder, etc.), banbury mixer, high-speed mixer, ross kettle, or other suitable device. As a specific example, Trexel, Inc., Woburn, Mass., USA, manufactures a supercritical fluid delivery system that provides metered mass flow of supercritical fluids (e.g., CO₂) to injection molding and extrusion machines.

Once a melt phase that comprises molten polymer and supercritical fluid is prepared, polymeric materials for use in medical articles in accordance with the present invention may be formed from the melt phase using any of a variety of thermoplastic processing techniques. Examples of suitable thermoplastic processing techniques may be selected from the following, among others: sheet and profile extrusion (e.g., extrusion into sheets, fibers, rods, tubes and other cross-sectional profiles of various lengths), melt spraying techniques, injection molding, blow molding, blown film processing, cast film processing, and combinations of these processes. Using these and other thermoplastic processing techniques, entire devices or portions thereof can be made.

Thus, in some embodiments of the invention, a melt phase is applied to a substrate to form a polymeric material. For example, the substrate can correspond to all or a portion of an implantable or insertable medical device to which a polymeric coating is applied, for example, by spraying, extrusion, fiber wrapping, and so forth. The substrate can also be, for example, a template, such as a mold, from which the polymeric material is separated after solidification. In other embodiments, for example, extrusion and co-extrusion techniques, polymeric materials are formed without the aid of a substrate.

Melt viscosity will vary from process to process with melt viscosities of 10 to 20 to 50 to 100 to 200 to 500 Pa-s being typical. Some processes are more demanding than others. For example, thermal fiber spinning of small diameter (≦50 μm) fiber requires very low melt viscosities (≦60 Pa-s), with fiber diameters in the 10 to 50 μm range requiring melt viscosities of the order of 30 to 60 Pa-s. Similarly low melt viscosities are also required for injection molding of certain articles. The attainment of the necessary melt viscosity values at non-destructive processing temperatures, however, is a difficult problem to resolve for various polymers and polymer blends, particularly where one wishes to avoid the use of additives that lower melt viscosity but remain in the formed product. This has prevented some polymers from being used in thermal spinning and injection molding operations, among others. Through the methods of the present invention, however, melt viscosity ranges required for various thermal processing techniques can be attained without the use of additives that lower melt viscosity but remain in the formed product, many of which are toxic or even carcinogenic.

In this regard, the addition of a supercritical fluid to a polymer during processing can accomplish several goals. For example, as noted above, the supercritical fluid produces lower melt viscosity during processing, allowing various polymers to be melt processed at temperatures below their degradation temperature. For example, depending on the supercritical fluid concentration, melt viscosities can reach very low levels (≦60 Pa-s), such as those required for thermal spinning of small diameter fibers or for injection molding, while at the same time avoiding thermal polymer degradation. Moreover, because CO₂ and other known supercritical fluids are considered to be non-toxic and non-carcinogenic, issues relating to leaching of harmful processing aids are avoided. Furthermore, CO₂ and certain other known supercritical fluids revert to the gas phase at atmospheric pressure and room temperature and thus may be passively removed from the polymer (e.g., by diffusion).

Examples of chemical species from which suitable supercritical fluids may be formed and used in accordance with the present invention can be selected from the following, among many others: ethylene, propane, CO₂, cyclohexane, toluene, dimethyl ether, n-pentane, butane/ethylene, hexane/ethylene, methyl cyclopentane, propane/10% ethanol, propane/0-41% acetone, CHClF₂, CHClF₂/0-39% ethanol.

As used herein, a “polymeric material” or “polymeric region” is a material or region (which may, for example, correspond to an entire device, a portion of a device, and so forth) that contains polymers, for example, from 50 wt % or less to 75 wt % to 90 wt % to 95 wt % to 97.5 wt % to 99 wt % or more polymers.

In some embodiments, the polymeric regions of the present invention correspond to an entire medical device. In other embodiments, the polymeric regions correspond to one or more portions of a medical device. For instance, the polymeric regions can be in the form of medical device components, in the form of one or more fibers which, in the form of one or more polymeric coating layers formed over all or only a portion of an underlying substrate, and so forth. Materials for use as underlying medical device substrates include ceramic, metallic and polymeric substrates. The substrate material can also be formed from carbon- or silicon-based ceramic-type materials, among others. Layers can be provided over an underlying substrate at a variety of locations and in a variety of shapes (e.g., in the form of a series of rectangles, stripes, or any other continuous or non-continuous pattern). As used herein a “layer” of a given material is a region of that material whose thickness is small compared to both its length and width. As used herein a layer need not be planar, for example, taking on the contours of an underlying substrate. Layers can be discontinuous (e.g., patterned).

As used herein, “polymers” are molecules containing multiple copies (e.g., from 2 to 5 to 10 to 25 to 50 to 100 to 1000 to 10,000 to 100,000 to 1,000,000 or more copies) of one or more constitutional units, commonly referred to as monomers. As used herein, the term “monomers” may refer to the free monomers and those that are incorporated into polymers, with the distinction being clear from the context in which the term is used.

Polymers may take on a number of configurations, which may be selected, for example, from linear, cyclic and branched configurations, among others. Branched configurations include star-shaped configurations (e.g., configurations in which three or more chains emanate from a single branch point), comb configurations (e.g., configurations having a main chain and a plurality of side chains, also referred to sometimes as “graft” configurations), dendritic configurations (e.g., arborescent and hyperbranched polymers), and so forth.

As used herein, “homopolymers” are polymers that contain multiple copies of a single constitutional unit. “Copolymers” are polymers that contain multiple copies of at least two different constitutional units, examples of which include random, statistical, gradient, periodic (e.g., alternating) and block copolymers.

As used herein, “block copolymers” are copolymers that contain two or more polymer blocks that differ in composition, for instance, because a constitutional unit (i.e., a monomer) is found in one polymer block that is not found in another polymer block. As used herein, a “polymer block” or “block” is a grouping of constitutional units (e.g., 5 to 10 to 25 to 50 to 100 to 250 to 500 to 1000 or more units). Blocks can be unbranched or branched. Blocks can contain a single type of constitutional unit (also referred to herein as “homopolymeric blocks”) or multiple types of constitutional units (also referred to herein as “copolymeric blocks”) which may be present, for example, in a random, statistical, gradient, or periodic (e.g., alternating) distribution. As used herein, a “chain” is a linear polymer or a portion thereof, for example, a linear block.

Examples of polymers for use in the present invention may be selected from the following, among others: polystyrene, polyethylene and polyethylene copolymers such as poly(ethylene-co-propylene), poly(ethylene-co-methacrylates) such as poly(ethylene-co-methyl methacrylate), poly(ethylene-co-methyl acrylate) and poly(ethylene-co-acrylic acid), other hydrocarbon homopolymers and copolymers such as polypropylene, poly-1-butene, polyisobutylene, polybutadiene and poly(isobutylene-co-styrene), polymethyl methacrylate homopolymers and copolymers, including polystyrene-b-polymethyl methacrylate, polydecyl methacrylate homopolymers and copolymers, poly n-butyl acrylate homopolymers and copolymers, poly tetrahydrofluorodecyloacrylate homopolymers and copolymers, aromatic polyesters (e.g., polyethylene terephthalate), poly ε-caprolactone homopolymers and copolymers, poly L-lactic acid homopolymers and copolymers, poly glycolic acid homopolymers and copolymers, poly dimethyl siloxane homopolymers and copolymers, polyethylene glycol homopolymers and copolymers, poly hexa-fluoro propylene oxide homopolymers and copolymers, and polycaprolactam homopolymers and copolymers, among others.

In some embodiments, the selected polymer is a block copolymer in which two or more hard blocks are separated from one another by an immisicble soft elastomeric block. One example of such a polymer is poly(styrene-b-isobutylene-b-styrene). Copolymers of this type are capable of demonstrating high strength and elastomeric properties, while at the same time being processable using melt-based processing techniques.

Examples of medical articles for the practice of the present invention vary widely and include, for example, medical tubing, stents (including coronary vascular stents, peripheral vascular stents, cerebral, urethral, ureteral, biliary, tracheal, gastrointestinal and esophageal stents), stent coverings, stent grafts, vascular grafts, catheters (e.g., renal or vascular catheters such as balloon catheters and various central venous catheters), guide wires, balloons, filters (e.g., vena cava filters and mesh filters for distil protection devices), abdominal aortic aneurysm (AAA) devices (e.g., AAA stents, AAA grafts, etc.), vascular access ports, dialysis ports, embolization devices including cerebral aneurysm filler coils (including Guglilmi detachable coils and metal coils), embolic agents, septal defect closure devices, myocardial plugs, patches, sutures, suture anchors, tissue staples and ligating clips at surgical sites, cannulae, metal wire ligatures, urethral slings, hernia “meshes,” artificial ligaments, orthopedic prosthesis such as bone grafts, bone plates, fins and fusion devices, spinal discs and nuclei, joint prostheses, orthopedic fixation devices such as interference screws in the ankle, knee, and hand areas, tacks for ligament attachment and meniscal repair, rods and pins for fracture fixation, screws and plates for craniomaxillofacial repair, and dental devices such as dental implants, drug depots that are adapted for placement in an artery for treatment of the portion of the artery distal to the device, pacemakers, lead coatings including coatings for pacemaker leads, defibrillation leads and coils, ventricular assist devices including left ventricular assist hearts and pumps, total artificial hearts, shunts, valves including heart valves and vascular valves, anastomosis clips and rings, cochlear implants, tissue bulking devices, and tissue engineering scaffolds for cartilage, bone, skin and other in vivo tissue regeneration, and biopsy devices, among others.

In some embodiments, the medical devices of the invention are suitable for long-term implantation. As used herein, “long-term” implantation means implantation periods of 1 month or greater, for example, ranging from 1 month to 3 months to 6 months to 12 months to 24 months or even longer, including the remaining lifetime of the patient.

As noted above, the present invention employs supercritical fluids to provide low melt viscosity levels, such as those required to melt spin small diameter fibers, without the need to resort to chemical additives that remain in the fiber after processing.

Fibers employed in the practice of the invention can vary widely in size, but are typically less than 50 μm across, for example, ranging from 50 μm to 25 μm to 10 μM to 5 μm to 2.5 μm to 1 μm to 0.5 μm (500 nm) to 0.25 μm (250 nm) to 0.1 μm (100 nm), or less.

Fibers can be melt spun through extrusion nozzles, which form part of a “spin pack,” having one or more orifices, which may also be referred to as distributors, jets or spinnerets in the melt spinning art. In the present invention, a melt phase comprising molten polymer and supercritical fluid may be extruded into fibers. Fibers having a variety of cross-sectional shapes may be formed, depending upon the shape of the orifice(s). Some examples of fiber cross-sections include polygonal (e.g., triangular, rectangular, hexagonal, etc.), circular, oval, multi-lobed, and annular (hollow) cross-sections, among others. The resulting fiber is typically taken upon a rotating mandrel or another take-up device. During take up, the fiber may be stretched (i.e., drawn) to orient the polymer molecules in some embodiments.

A specific example of a non-woven technique for forming three-dimensional structures from fibers is described in U.S. Pat. No. 4,475,972, in which articles are made by a procedure in which fibers are wound upon a mandrel and overlying fiber portions are simultaneously bonded with underlying fiber portions, which method may be adapted to the present invention.

For instance, melt phase like that described above may be extruded from a spin pack containing one or more extrusion orifices, and the resulting fibers are wound onto a rotating mandrel, for example, as the spin pack reciprocates back and forth relative to the mandrel, or vice versa. Such activity will result in combined rotational and translational movement between the spin pack and the mandrel. The cooling parameters (e.g., cooling environment, fiber take-up speed, spinneret-to-mandrel distance, etc.) may be controlled such that the individual polymeric molecules within the fiber maintain their mobility as the fiber is wrapped upon the mandrel. Upon further cooling, the overlapping fibers on the mandrel become bonded to each other due to polymeric diffusion and interpenetration at various locations where the fibers intersect or otherwise contact each other. Such fiber-to-fiber bonding results when the partially-solidified fibers engage one another during winding. This engagement may be enhanced, for example, by increasing the temperature of the fiber at the time it engages the mandrel, by drawing the extruded fibers, and so forth. These activities may also reduce the diameter of the fiber.

The size and/or shape of the pores that are defined by the fibers may be controlled, for instance, by controlling the angle at which the fibers are wrapped upon the mandrel (which depends, for example, on the winding speed of the mandrel relative to the reciprocation speed of the distributor, etc.), by controlling the diameter of the fibers (which depends, for example, on the melt viscosity of the liquid, the flow rate of the liquid through the spin pack, the draw rate, etc.), by controlling the degree of flattening of the fibers (e.g., by increasing the temperature of the fiber at the point where it engages the spinning mandrel), and so forth.

Pore size may vary widely in such regions, ranging from less than 1 micron to 1 micron to 2 microns to 5 microns to 10 microns to 25 microns to 50 microns to 100 microns or more. Where pore size is given it is the number average pore width and may be measured, for example, using optical microscopy or scanning electron microscopy (SEM). Pores need not be cylindrical. For example, in embodiments where porous regions are formed from fibers, such fibers may overlap at various angles and therefore appear to be randomly distributed and sized upon examination by microscopy.

The thickness of the fibrous region that is produced on the mandrel may be controlled, for instance, by varying the length of the fiber wound on the mandrel, by varying the width of the individual fibers, by varying the temperature of the fiber at the time it engages the mandrel (e.g., if the fiber is more molten it may flatten and it may sink into the underlying layer, requiring more fiber passes to reach a desired thickness), and so forth.

In certain embodiments of the invention, electrostatic spinning processes may be employed. Electrostatic spinning processes have been described, for example, in Annis et al. in “An Elastomeric Vascular Prosthesis”, Trans. Am. Soc. Artif. Intern. Organs, Vol. XXIV, pages 209-214 (1978), U.S. Pat. No. 4,044,404 to Martin et al., U.S. Pat. No. 4,842,505 to Annis et al., U.S. Pat. No. 4,738,740 to Pinchuk et al., and U.S. Pat. No. 4,743,252 to Martin Jr. et al. In electrostatic spinning, electrostatic charge generation components are employed to develop an electrostatic charge between the spin pack and the mandrel. For example, the mandrel may be grounded or negatively charged, while the spin pack is positively charged. Alternatively, the spin pack may be grounded or negatively charged, while the mandrel can be positively charged. The potential that is employed may be constant or variable. As a result of the electrostatic charge that is generated, the polymeric fibers experience a force that accelerates them from the spin pack to the mandrel. Also, the fibers may have a tendency to flap, wobble and/or vibrate. Consequently, structures may be created which have smaller diameter fibers in a more random distribution, relative to the same structures formed in the absence of the electrostatic charge. Moreover, contact between the fibers may be enhanced, because the fibers are electrostatically drawn onto the mandrel, in some instances causing the fibers to sink to some extent into underlying fibers.

As can be appreciated from the foregoing, a wide variety of medical devices may be formed from fibers in accordance with the present invention. These include closed-volume (hollow) medical devices, such as tubular articles (e.g., vascular and non-vascular grafts and stent grafts, including large and small vascular grafts such as coronary artery bypass grafts, peripheral vascular grafts and endovascular grafts, other tubular structures such as biliary, urethral, ureteral, intestinal and esophageal tubular structures, etc.), as well as various open-volume medical devices such as vascular and non-vascular patches (e.g., patches for wound healing, patches for hernia repair and patches for the gastrointestinal tract and the urogenital system). They may be formed using any suitable fiber-based construction technique including, for example, various woven and non-woven (e.g., knitted, braided, coiled, randomly wrapped, etc.) techniques. Examples of non-woven techniques include those that utilize thermal fusion, mechanical entanglement, and so forth.

Further examples of fiber-based medical devices include vascular and non-vascular tissue scaffolding, vascular and non-vascular closure devices, for example devices for closure of peripheral and arterio-venous fistula, sutures, meshes, valve leaflets for heart valves and venous valves, vascular access devices including vascular access ports and arterio-venous access grafts (e.g., devices which are utilized to give frequent arterial and/or venous access such as for antibiotics, total parental nutrition, intravenous fluids, blood transfusion, blood sampling, or arterio-venous access for hemodialysis, and so forth), embolic filters (e.g., distal protection filters), uterine slings, fabric to join LVADs (left ventricular assist devices) and TAHs (total artificial hearts) to human arteries, and so forth.

Fibrous coating layers may be provided over substrates corresponding to a wide variety devices, including, for example, stents, catheters (e.g., renal or vascular catheters such as balloon catheters and various central venous catheters), guide wires, balloons, embolization devices including cerebral aneurysm filler coils (including Guglilmi detachable coils and metal coils), pacemakers and pacemaker leads, defibrillation leads and coils, left ventricular assist hearts and pumps, total artificial hearts, anastomosis clips and rings, and cannulae, among many others.

Fibrous coating layers may be provided both over and under substrates corresponding to a wide variety devices, including, for example, stents, and other tubular devices, for example, by first depositing a fibrous layer over a rotating mandrel, placing the medical device over the fibrous layer, and then forming an additional fibrous layer over the rotating medical device.

Hollow medical devices (including any tubular shape, such as those having circular and elliptical cross-sections) for use in the present invention may vary widely in diameter, for example, ranging from 0.5 mm to 1 mm to 2 mm to 5 mm to 10 mm to 20 mm to 50 mm or more in diameter. For instance, tubular articles having diameters ranging from 0.5 to 2 mm may be employed for microvascular work and conduits for nerve regeneration, those having diameters ranging from 2 to 4 mm may be employed for coronary bypass, those having diameters ranging from 2 to 10 mm, may be employed peripheral vascular grafts, those having diameters ranging from 20 to 50 mm and above may be employed for endovascular and endoluminal vascular grafts, other tubular prosthesis such as esophageal and colonic prosthesis, and so forth.

For tubular structures made using a rotating mandrel, the inside diameter will depend upon the size of the mandrel, with typical mandrel diameters ranging from 1 mm or less to 50 mm or more. Larger diameter mandrels are also suitable, for example, for forming tubular articles, which may be cut into sheets or otherwise shaped for making two-dimensional (open) structures such as patches and scaffolds.

More complex hollow structures may also be formed. For example, by selecting a tapered (i.e., with a gradual diameter change) or stepped (i.e., with an abrupt diameter change) mandrel, a tapered or stepped tubular structure is readily produced. Even more complex structures may be formed using mandrels that may be dissolved, melted, deflated or other otherwise reduced in size for removal after the structure is formed.

### EXAMPLE

Poly(styrene-b-isobutylene-b-styrene) triblock copolymer (SIBS) is prepared by cationic polymerization, for example, as described in U.S. Pat. No. 6,545,097 to Pinchuk et al. In order to thermally spin SIBS to produce fibers ranging from 10 to 50 μm diameter, a melt viscosity in the range of 30 to 60 Pa-s is needed. Under normal thermal processing conditions, SIBS cannot be extruded at extruder barrel temperatures greater than about 475° F. (218° C.) without chemical degradation occurring. Degradation is observed as a darkening of the extrudate. At that temperature, even at high shear rates, the melt viscosity is about 150 Pa-s—too high for small diameter fiber thermal spinning.

The addition of CO₂ to the processing thermal melt, in the desired concentrations and at the desired pressures, can reduce the melt viscosity significantly, allowing thermal processing at lower melt viscosities at temperatures that do not exceed the degradation temperatures of the polymer. In addition, once extruded, the CO₂ sublimes into a gas and is totally eliminated from the extrudate, rendering the final extrudate to be 100% SIBS with no additives that might leach out upon implantation or insertion into a subject.

17 Mole % Styrene SIBS is provided in pieces of about 1 mm×1 mm×1 mm. These are loaded into an extruder (Wayne Machine and Die Co., Totowa, N.J., USA) having the following specifications: ¾″ single screw extruder in which flights in the metering zone are closely spaced to increase pressure, grooved at the injection port to allow pressure drop, wherein several closely spaced flights are provided after the injection port to allow for a suitable pressure increase; the extruder is equipped with a Saxton mixing section; barrel diameter=¾ inch, extended length; L/D ratio of screw=30/1. The extruder is operated at a screw rpm=2-6 and an extrusion temperature at the die of 200° C. The gas used is CO₂, which is introduced using a flow meter at various pressures and flow rates. The gas is introduced into the metering zone of extruder. Barrel pressures are as follows: SIBS=3000 to 5200 psig; SIBS mixed with CO₂=5500 to 6200 psig. The amount of CO₂ introduced into the SIBS during extrusion is estimated to be about 36%. CO₂ flow rates are typically around 0.4 ml/min, but this can vary depending on the barrel pressures (i.e., if the barrel pressure is low, then the CO₂ rate is high, and visa-versa).

Although various embodiments are specifically illustrated and described herein, it will be appreciated that modifications and variations of the present invention are covered by the above teachings and are within the purview of the appended claims without departing from the spirit and intended scope of the invention.

1. A method of forming a medical article comprising (a) preparing a melt phase that comprises a molten polymer and a supercritical fluid, (b) forming a polymeric region from the melt phase and (c) cooling the polymeric region.

2. The method of claim 1, wherein the melt phase consists essentially of the molten polymer and the supercritical fluid.

3. The method of claim 1, wherein the melt phase has a melt viscosity of less than 60 Pa-s.

4. The method of claim 4, wherein the melt viscosity of less than 60 Pa-s cannot be obtained by heating the material in the absence of a viscosity-reducing additive without thermal degradation of the polymer occurring.

5. The method of claim 1, wherein the polymer is selected from block copolymers with immiscible blocks and polyesters.

6. The method of claim 1, wherein the polymer is selected from styrene-isobutylene block copolymers, ethylene-styrene block copolymers, butadiene-styrene block copolymers and polyethylene terephthalate.

7. The method of claim 1, wherein the supercritical fluid is a gas at room temperature and atmospheric pressure.

8. The method of claim 1, wherein the polymeric region is formed by injecting the molten phase into a mold.

9. The method of claim 1, wherein the polymeric region is formed by extruding the molten phase from an orifice.

10. The method of claim 9, wherein the polymeric region is extruded into air at room temperature or below.

11. The method of claim 9, wherein the polymeric region is an extruded sheet.

12. The method of claim 9, wherein the polymeric region is an extruded tube.

13. The method of claim 9, wherein the polymeric region is an extruded fiber.

14. The method of claim 13, wherein the extruded fiber is wound on a rotating substrate.

15. The method of claim 14, wherein the rotating substrate is a removable substrate.

16. The method of claim 14, wherein the rotating substrate is a medical article.

17. The method of claim 16, wherein the medical article is an implantable or insertable medical device.

18. A medical article made by the process of claim 1.

19. The medical article of claim 18, wherein medical article comprises a tube or sheet that corresponds to the cooled polymeric region.

20. The medical article of claim 18, wherein medical article comprises a fiber that corresponds to the cooled polymeric region.

21. The medical article of claim 20, wherein the medical article comprises a medical article substrate and a woven or nonwoven coating that comprises the fiber.

22. The medical article of claim 20, wherein the fiber is less than 50 μm in diameter.

23. The medical article of claim 22, wherein the fiber comprises a copolymer of styrene and isobutylene.

24. The medical article of claim 18, wherein the medical article comprises a medical article substrate and a coating that comprises the cooled polymeric region.

25. The medical article of claim 18, wherein the medical article is an implantable or insertable medical device.

26. A medical article comprising a melt processed polymeric material, said polymeric material containing no melt-viscosity reducing additives, and said polymeric material having a composition that cannot be melt processed without the use of melt-viscosity reducing additives.
